(19) United States
(12) Patent Application Publication
(10) Pub. No.: US 2025/0193827 A1
(43) Pub. Date: Jun. 12, 2025

(54) COMMUNICATION DEVICE, METHOD, AND APPARATUS, AND COMPUTER-READABLE MEDIUM

(71) Applicant: Nokia Solutions and Networks Oy, Espoo (FI)

(72) Inventors: Ye LUO, Shanghai (CN); Zhi Jie YANG, Shanghai (CN); Orhan Okan MUTGAN, Shanghai (CN); Jun TAN, Bellevue, WA (US); Dongdong ZHU, Bellevue, WA (US)

(73) Assignee: Nokia Solutions and Networks Oy, Espoo (FI)

(21) Appl. No.: 18/969,846

(22) Filed: Dec. 5, 2024

(30) Foreign Application Priority Data
Dec. 8, 2023 (CN) 202311688793.6

(51) Int. Cl. H04W 60/04; H04W 28/24; H04W 40/24

(52) U.S. Cl. CPC H04W 60/04; H04W 28/24; H04W 40/24

(57) ABSTRACT

Embodiments of the present disclosure relate to a communication device, method, and apparatus, and a computer-readable medium. In one aspect, a first access point (AP) device assigns a device identification to a station (STA) device during performing an association process with the STA device. In addition, the first AP device transmits the device identification assigned to the STA device to at least one of a second AP device or a control device. In this way, the performance of a communication network can be improved. For example, an EasyMesh network with improved performance can be achieved.

### FIELD

Embodiments of the present disclosure generally relate to the field of communications, and more particularly, to a communication device, method, and apparatus, and a computer-readable medium.

### BACKGROUND

The increasing number of residential or small business networks take multi-AP deployment to resolve coverage issue of communication networks (such as Wi-Fi) and to improve user experience. Wi-Fi Alliance Wi-Fi EasyMesh program defines the control protocols between APs, mechanisms to route traffic within the network, and the data objects necessary to enable easy onboarding, configuration, control, and automated management of APs in a Wi-Fi EasyMesh network.

A communication network (such as a Wi-Fi EasyMesh network) may consist of one controller and one or more agents. EasyMesh controller is responsible for monitoring the network conditions, managing the network, configuring the radios on the APs and optimizing the network operation. EasyMesh Agents may be responsible for collecting and reporting measurements and capabilities in the Wi-Fi EasyMesh network. In addition, EasyMesh Agents can perform the commands sent from the controller and provide the Wi-Fi service to client devices. However, the communication networks (such as the Wi-Fi EasyMesh network) still need to be optimized and improved.

### SUMMARY

Generally, exemplary embodiments of the present disclosure relate to a technical solution for wireless communication, in particular, to a technical solution for improving the performance of a communication network (such as an EasyMesh network), for example, provide a mechanism for identifying a non-access point (AP) station with a random changing media access control (MAC) address (RCM) in a multi-AP network.

In a first aspect of the present disclosure, a first access point (AP) device is provided. The first AP device includes at least one processor; and at least one memory storing instructions that, when executed by the at least one processor, cause the first AP device at least to: assign a device identification to a station (STA) device during performing an association process with the STA device; and transmit the device identification to at least one of a second AP device or a control device.

In a second aspect of the present disclosure, a second AP device is provided. the second AP device includes: at least one processor; and at least one memory storing instructions that, when executed by the at least one processor, cause the second AP device at least to: receive, from a first AP device, a device identification assigned by the first AP device to an STA device; and perform communication with the STA device based on the device identification.

In a third aspect, a control device is provided. The control device includes: at least one processor; and at least one memory storing instructions that, when executed by the at least one processor, cause the control device at least to: receive, from a first AP device, a device identification assigned by the first AP device to an STA device; and control, based on the device identification, an operation related to the STA device.

In a fourth aspect of the present disclosure, an STA device is provided. The STA device includes: at least one processor; and at least one memory storing instructions that, when executed by the at least one processor, cause the STA device at least to: obtain, during performing an association process with a first AP device, from the first AP device, a device identification assigned by the first AP device to the STA device; and perform communication with the second AP device based on the device identification.

In a fifth aspect of the present disclosure, a communication method is provided. The communication method includes: assigning, at a first AP device, a device identification to an STA device during performing an association process with the STA device; and transmitting the device identification to at least one of a second AP device or a control device.

In a sixth aspect of the present disclosure, a communication method is provided. The communication method includes: receiving, at a second AP device and from a first AP device, a device identification assigned by the first AP device to an STA device; and performing communication with the STA device based on the device identification.

In a seventh aspect of the present disclosure, a communication method is provided. The communication method includes: receiving, at a control device and from a first AP device, a device identification assigned by the first AP device to an STA device; and controlling, based on the device identification, an operation related to the STA device.

In an eighth aspect of the present disclosure, a communication method is provided. The communication method includes: obtaining, at an STA device, during performing an association process with a first AP device and from the first AP device, a device identification assigned by the first AP device to the STA device; and performing communication with a second AP device based on the device identification.

In a ninth aspect of the present disclosure, a communication apparatus is provided. The communication apparatus includes: means for assigning, at a first AP device, a device identification to an STA device during performing an association process with the STA device; and means for transmitting the device identification to at least one of a second AP device or a control device.

In a tenth aspect of the present disclosure, a communication apparatus is provided. The communication method includes: means for receiving, at a second AP device and from a first AP device, a device identification assigned by the first AP device to an STA device; and means for performing communication with the STA device based on the device identification.

In an eleventh aspect of the present disclosure, a communication apparatus is provided. The communication apparatus includes: means for receiving, at a control device and from a first AP device, a device identification assigned by the first AP device to an STA device; and means for controlling, based on the device identification, an operation related to the STA device.

In a twelfth aspect of the present disclosure, a communication apparatus is provided. The communication apparatus includes: means for obtaining, at an STA device, during performing an association process with a first AP device, and from the first AP device, a device identification assigned by the first AP device to the STA device; and means for performing communication with a second AP device based on the device identification.

In a thirteenth aspect of the present disclosure, a non-transitory computer-readable medium is provided, including program instructions used for causing an apparatus to at least perform any method in the fifth aspect to the eighth aspect.

In a fourteenth aspect of the present disclosure, a non-transitory computer-readable medium is provided, including program instructions stored thereon. The program instructions perform at least any method in the fifth aspect to the eighth aspect.

In a fifteenth aspect of the present disclosure, a computer program including instructions is provided. When executed by an apparatus, the computer program causes the apparatus at least to: assign, at a first AP device, a device identification to an STA device during performing an association process with the STA device; and transmit the device identification to at least one of a second AP device or a control device.

In a sixteenth aspect of the present disclosure, a computer program including instructions is provided. When executed by an apparatus, the computer program causes the apparatus at least to: receive, at a second AP device and from a first AP device, a device identification assigned by the first AP device to an STA device; and perform communication with the STA device based on the device identification.

In a seventeenth aspect of the present disclosure, a computer program including instructions is provided. When executed by an apparatus, the computer program causes the apparatus at least to: receive, at a control device and from a first AP device, a device identification assigned by the first AP device to a station (STA) device; and control, based on the device identification, an operation related to the STA device.

In an eighteenth aspect of the present disclosure, a computer program including instructions is provided. When executed by an apparatus, the computer program causes the apparatus at least to: obtain, at an STA device, during performing an association process with a first AP device, and from the first AP device, a device identification assigned by the first AP device to the STA device; and perform communication with a second AP device based on the device identification.

In a nineteenth aspect of the present disclosure, a first AP device is provided. The first AP device includes an assigning circuit for assigning a device identification to an STA device during performing an association process with the STA device; and a transmitting circuit for transmitting the device identification to at least one of a second AP device or a control device.

In a twentieth aspect of the present disclosure, a second AP device is provided. The second AP device includes a receiving circuit for receiving, from a first AP device, a device identification assigned by the first AP device to an STA device; and a performing circuit for performing communication with the STA device based on the device identification.

In a twenty-first aspect of the present disclosure, a control device is provided. The control device includes a receiving circuit for receiving, from a first AP device, a device identification assigned by the first AP device to an STA device; and a control circuit for controlling, based on the device identification, an operation related to the STA device.

In a twenty-second aspect of the present disclosure, an STA device is provided. The STA device includes an obtaining circuit for obtaining, during performing an association process with a first AP device, and from the first AP device, a device identification assigned by the first AP device to the STA device; and a performing circuit for performing communication with the second AP device based on the device identification.

It should be understood that the content described in the summary section is not intended to limit the key or important features of the embodiments of the present disclosure, and is not intended to limit the scope of the present disclosure. Other features of the embodiments of the present disclosure will be easily understood through the following description.

### BRIEF DESCRIPTION OF THE DRAWINGS

FIG. 1 shows a block diagram of an exemplary communication system where the embodiments of the present disclosure can be implemented.

FIG. 2 shows a flowchart of an interaction between communication devices according to some embodiments of the present disclosure.

FIG. 3 shows a flowchart of an interaction between communication devices according to some embodiments of the present disclosure.

FIG. 4 shows a flowchart of an interaction between communication devices according to some embodiments of the present disclosure.

FIG. 5 shows a flowchart of an interaction between communication devices according to some embodiments of the present disclosure.

FIG. 6 shows a flowchart of an interaction between communication devices according to some embodiments of the present disclosure.

FIG. 7 shows a flowchart of an interaction between communication devices according to some embodiments of the present disclosure.

FIG. 8 shows a schematic diagram of a flow performed by a first AP device according to some embodiments of the present disclosure.

FIG. 9 shows a schematic diagram of a flow performed by a second AP device according to some embodiments of the present disclosure.

FIG. 10 shows a schematic diagram of a flow performed by a control device according to some embodiments of the present disclosure.

FIG. 11 shows a schematic diagram of a flow performed by an STA device according to some embodiments of the present disclosure.

FIG. 12 is a simplified block diagram of an electronic device suitable for implementing the embodiments of the present disclosure.

FIG. 13 shows a schematic diagram of a computer-readable medium suitable for implementing the embodiments of the present disclosure.

In all the accompanying drawings, identical or similar reference numerals represent identical or similar elements.

### DETAILED DESCRIPTION OF EMBODIMENTS

The principle and spirit of the present disclosure will be described below by referring to several exemplary embodiments shown in the accompanying drawings. It should be understood that the descriptions of these specific embodiments are to enable those skilled in the art to better understand and implement the embodiments of the present disclosure, and are not intended to limit the scope of the present disclosure in any way.

The term “include” and its variants as used herein mean widespread inclusion, namely, “including but not limited to”. The term “based on” should be understood as “based at least in part on”. The term “one embodiment” or “this embodiment” should be understood as “at least one embodiment”. The terms “first”, “second”, and the like can refer to different or same objects. Other explicit and implicit definitions may also be included below.

As used herein, the term “determine” encompasses a variety of actions. For example, “determine” can include operation, calculation, processing, deriving, surveying, searching (such as searching a table, a database, or another data structure), investigation, and the like. In addition, “determine” may include receiving (for example, receiving information), accessing (for example, accessing data in a memory), and the like. In addition, “determine” can include parsing, selection, choosing, establishment, and the like. As used herein, “at least one of the following: <a list of two or more elements>”, “at least one of <a list of two or more elements>” and similar wordings, where the list of two or more elements is connected by “and” or “or”, mean at least any one of these elements, or at least any two or more of these elements, or at least all of the elements.

The term “circuitry” used herein refers to one or more of the following: (a) implementation of only a hardware circuit (such as an implementation of an analog and/or digital circuitry); (b) a combination of a hardware circuit and software, such as (if applicable): (i) a combination of an analog and/or digital hardware circuit and software/firmware, and (ii) any part of a hardware processor and software (including a digital signal processor, software, and a memory that work together to enable an apparatus such as radio frequency device or other computing device to perform various functions); and (c) a hardware circuit and/or processor, such as a microprocessor or a part of a microprocessor, that require software (such as firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit or a similar integrated circuit in other computing device.

In a typical EasyMesh network architecture, messages including configuration information, capabilities of an AP/STA, metrics, and operation requests/responses are transmitted through a Wi-Fi or an Ethernet backhaul during inter-communication between a controller and an agent. In these messages, a MAC address of an STA is a key field used for identifying and tracking each individual client device associated with the network. According to the latest EasyMesh specification, several scenarios below involve identifying a client device based on a MAC address of an STA.

Scenario 1 involves sensing and collect network topology information and topology changes. In an IEEE 1905 topology response message with an associated client type length value (TLV) and a 1905 topology notification message with a client association event TLV, a MAC address of an STA is transmitted between an EasyMesh controller and an agent, to identify each STA and its affiliated AP. Such messages and the TLVs may enable each EasyMesh node (controller and agent) to be aware of network topology changes.

Scenario 2 involves collecting capabilities and metrics of client devices. In an EasyMesh network, a controller collects the capabilities of all client devices, regularly gathers metric information to sense the status of the entire network, and then triggers some optimization operations to improve the performance of the entire network. An AP metrics response message includes an associated STA link metrics TLV, an associated STA traffic statistics TLV, an associated STA extended link metrics, and an associated Wi-Fi 6 STA status report TLV. An EasyMesh agent transmits, to the controller, a response about each associated STA metrics, such as an upstream/downstream data rate, a transmitting/receiving channel utilization and a queue size, through the response message. An unassociated STA link metrics query/response message includes an unassociated STA link metrics query/response TLV, by which the EasyMesh agent can collect unassociated STA receive channel power indicator (RCPI) information on a specific channel and then report the information to the controller, to further improve the performance of the network. The EasyMesh controller and agent also exchange beacon metrics information via a beacon metrics query/response TLV, and the controller collects a beacon report from a specific STA. In summary, in all the above cases related to the collection of the capabilities and metrics of the client devices, the MAC addresses of the STAs are used as device identifiers to confirm which STA information shall be collected.

Scenario 3 involves a network optimization action for a specific STA. The EasyMesh controller will take some network optimization measures based on the collected network device capabilities, metrics, and statistical data. Some optimization actions (such as steering and association control) are for specific client devices. To improve the performance of the overall network or the performance of a special STA, the EasyMesh controller can transmit a client steering request message carrying a steering request TLV or a Profile-2 steering request TLV to the agent to guide the STA to roam to the best basic service set identifier (BSSID). On another side, for an STA that does not support a 802.11v BTM request, the controller may send a client association control request message to guide some specific STA to be associated with an expected BSSID/AP.

Scenario 4 involves a transmission network optimization policy. Under a certain condition, the EasyMesh controller may leverage policies to manage and control network devices behavior, and then take necessary measures for optimization. For example, the controller may send the agent with the policies of some specific STAs, and the agent will trigger actions for behavior optimization.

In some use cases, the EasyMesh controller may send multi-AP policy configuration request message carrying the steering policy TLV to the agent to set the condition/threshold of triggering steering operation. For example, the controller may leverage QoS management policy TLVs to allow/disallow a Stream Classification Service (SCS) or Mirrored Stream Classification Service (MSCS) operation on the specified STA to enhance QoS management. In the case mentioned above, an STA's MAC address is used as a device identifier to recognize each client device to apply the policy.

In a 802.11 standard, the fixed and unencrypted STA's MAC address is widely used in frame headers, which enable unauthorized party identifying and tracking STAs based on the MAC address. To prevent the STA from being tracked and improve the privacy of 802.11, MAC address randomization became a common technique recently.

However, the usage of such Randomized Change MAC (RCM) also results in new issue that STA becomes more difficult to be identified and tracked when desired. Within this regard, IEEE 802.11bh and 802.11bi groups focus on identification of STAs using RCM without decreasing user privacy. 802.11bh focuses on device (i.e., non-AP STA) identification through MAC randomization in pre-association phase, while device (i.e., non-AP STA) still doesn't change MAC address after association (i.e., post-association). On the other hand, IEEE 802.11bi will address privacy concerns as a part of its work and manage to solve the case where a non-AP STA can also change its MAC address after association. Note that a non-AP STA is abbreviated as STA in the embodiments of the present disclosure. Device ID and/or IRM (Identifiable Random MAC) proposed by 802.11bh group can address the identification issue on standalone AP or AP-MLD with RCM (random changing MAC address).

There is currently no solution to address the identification issue in multi-AP network environment. Further explanation on the identification issue on multi-AP network are listed below.

Problem 1 is that a network topology is incorrect. In the EasyMesh network, when an STA associates/disassociates to/from any agent, the agent will send a client association event TLV carrying the client's MAC address to notify the controller and other agents the topology change. For example, one STA enabling RCM may roam the from AP1 to AP2. The network may think the STA with RCM1 disassociates from AP1 and a new STA with RCM2 associates to AP2. But in fact, STA with RCM1 or RCM2 is the same client device. Due to such unidentifiable issue on each associated client, the statistics and status relevant information on the certain STA probably are wrong as well.

Problem 2 is that a client steering decision is unsuitable. Client steering is one critical feature in the EasyMesh network for optimizing network performance. In some use cases, before the controller intends to send a client steering request message, it needs to collect some metrics, like RCPI, operation class and working channel, for one specific STA on each agent in advance. Based on which the network may make the further decision about which STAs are selected for steering, and when steering operation is triggered.

According to the latest EasyMesh specification, the associated STA link metrics TLV and the nunassociated STA link metrics TLV are sent from the controller to the agent to collect the STA's metrics, like RCPI. The controller will send associated STA link metrics TLV and unassociated STA link metrics TLV carrying the same STA's MAC to the affiliated AP and unaffiliated APs respectively. Regarding to the unassociated STA link metrics query, the unaffiliated AP obtains the expected RCPI information of a certain STA via matching the MAC address carried in the received probe request to the MAC address included in the unassociated STA link metrics TLV. Unfortunately, the STA may send a probe request with a new RCM, which causes the unaffiliated AP collecting RCPI information failure. And further result in a wrong client steering decision.

Problem 3 is an outdated QoS management policy and request. In an EasyMesh R4 specification, a WFA QOS management support is introduced to allow the controller enabling or disabling SCS/MSCS operation on a specific STA via the QoS management policy. For example, an AP may not negotiate QoS treatment for a particular traffic sent by a specified STA if such allow/disallow policy is configured from the controller to the agent. But if STA randomly changes its MAC, the policy of allowing/disallowing SCS/MSCS operation will become ineffective when a specified STA associates to such agent.

Besides a QoS management policy to allow/disallow SCS/MSCS negotiation, the controller can also configure an SCS/MSCS descriptor with a QoS management descriptor TLV included in a service prioritization request message. Such descriptor element can be propagated to any agents even specified STA not associated to it so that SCS/MSCS descriptors configured on any of agents are aligned and consistent on all of agents. However, if the STA changes its MAC during associating to another agent next time, such configuration based on STA MAC will not take effect and the expected QoS treatment for particular traffic specified in the QoS management descriptor will not happen.

The current technical solutions have not yet solved the problem caused by use of the RCM by the non-AP STA in the multi-AP network. In view of this, a device identifier synchronization mechanism is proposed to enhance communication network (e.g., the EasyMesh network) identifying and tracking STA, and enable optimization of the whole EasyMesh network. It should be pointed out that although the above analysis and description is given based on the examples of the EasyMesh network, the embodiments of the present disclosure are not limited to the EasyMesh network. In fact, the embodiments of the present disclosure can be equally or similarly applied to any communication network or communication system with similar defects or problems.

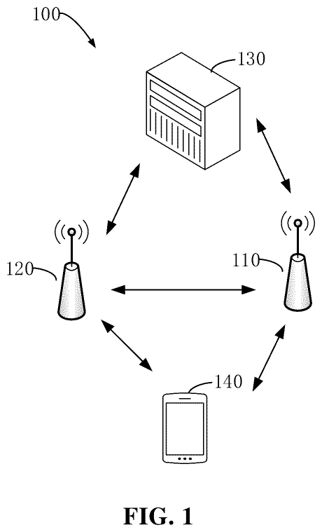

FIG. 1 shows a block diagram of an exemplary communication system where the embodiments of the present disclosure can be implemented. As shown in FIG. 1, the communication system 100 includes a plurality of communication devices, such as communication devices 110, 120, 130, and 140. The plurality of communication devices can communicate directly or indirectly with each other. For example, the communication device 110 can communicate with the other ones of the plurality of communication devices. In the present disclosure, the communication device 110 can be referred to as a first AP device 110; the communication device 120 can be referred to as a second AP device 110; the communication device 130 can be referred to as a control device 110; and the communication device 140 can be referred to as an STA device 110. It should be noted that an AP device can be referred to as an agent herein. It should be noted that the number of the communication devices in the embodiments of the present disclosure is not limited to the above example.

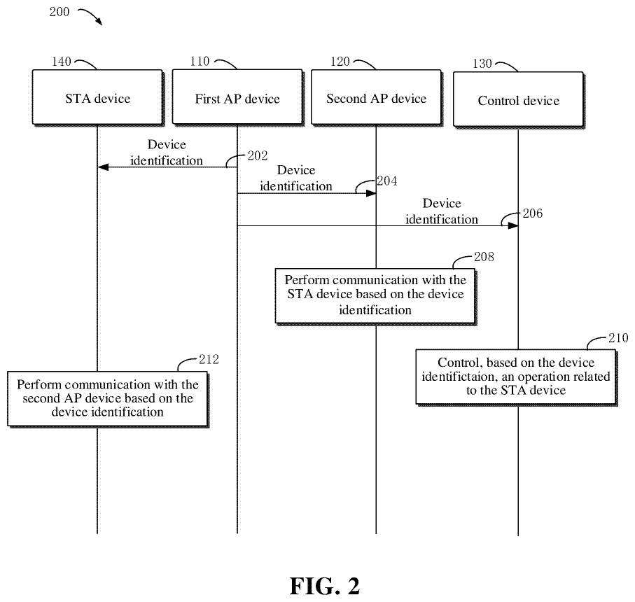

FIG. 2 shows a schematic flowchart of an interaction between communication devices according to some embodiments of the present disclosure. For ease of understanding, a flow 200 shown in FIG. 2 can be described referring to the devices involved in FIG. 1 (e.g. the AP devices 110 and 120, the control device 130, and the STA device 140).

At the first AP device 110, during performing an association process with the STA device 140, a device identification is assigned (202) to the STA device 140. Next, the first AP device 110 transmits (204, 206) the device identification to at least one of the second AP device 120 or the control device 130. In some embodiments, the device identification is transmitted in a 1905 topology notification message.

At the second AP device 120, the device identification assigned by the first AP device 110 to the STA device 140 is received (204) from the first AP device 110. For example, the device identification is received in the 1905 topology notification message. In some embodiments, the second AP device 120 may further store the device identification. Next, the second AP device 120 performs (208) communication with the STA device 140 based on the device identification.

At the control device 130, the device identification assigned by the first AP device 110 to the STA device 140 is received (206) from the first AP device 110. For example, the device identification is received in the 1905 topology notification message. In some embodiments, the control device 130 may further store the device identification. The control device 130 controls (210), based on the device identification, an operation related to the STA device 140.

At the STA device 140, during performing the association process with the first AP device 110, the device identification assigned by the first AP device 110 to the STA device 140 is obtained (202) from the first AP device 110, and communication with the second AP device 120 is performed (212) based on the device identification.

In some embodiments, the 1905 topology notification message may include a client association event type length value (TLV). The client association event TLV may include bit information, and the bit information may be used for indicating whether the device identification is used.

In some embodiments, if the TLV indicates that the device identification is used, the 1905 topology notification message may further include a client device identification TLV. The client device identification TLV may include the device identification and a media access control (MAC) address of the STA device 140. Alternatively or additionally, in addition to the device identification, the client device identification TLV may further include a MAC address of the first AP device 110.

In some embodiments, the control device 130 may perform the operation related to the STA device 140 through the following operations, and the second AP device 120 and the STA device 140 may perform the communication through the following operations. First, the control device 130 transmits a link metrics query TLV for the STA device 140 to the second AP device 120. The link metrics query TLV includes the device identification. Correspondingly, at the second AP device 120, the link metrics query TLV for the STA device 140 is received from the control device 130. Based on the received link metrics query TLV, the second AP device 120 may monitor a probe request message transmitted from the STA device 140. The probe request message may include the device identification. In a case that the probe request message has been monitored, the second AP device 120 may obtain link metrics information of the STA device 140 based on the probe request message. Next, the second AP device 120 may transmit a link metrics response TLV to the control device 130. The link measure response TLV may include the device identification and the link metrics information. At the control device 130, the link metrics response TLV is received from the second AP device 120.

In some embodiments, the control device 130 may perform the operation related to the STA device 140 through the following operations. The control device 130 transmits a quality of service (QOS) management policy TLV to at least one of the first AP device 110 or the second AP device 120. The QoS management policy TLV includes a list of device identifications for which QoS treatment negotiation is disallowed. Correspondingly, at the first AP device 110, the QOS management policy TLV can be received from the control device 130. The first AP device 110 may further receive a QoS treatment negotiation request from the STA device 140 and determine, based on the QoS management policy TLV, whether to allow the QoS treatment negotiation request of the STA device 140. Correspondingly, at the second AP device 120, the QoS management policy TLV may also be received from the control device 130. The second AP device 120 may further perform the communication with the STA device 140 through the following operations. For example, the second AP device 120 may receive a QoS treatment negotiation request from the STA device 140 and determine, based on the QoS management policy TLV, whether to allow the QoS treatment negotiation request of the STA device 140.

In some other embodiments, the control device 130 may perform the operation related to the STA device 140 through the following operations. First, the control device 130 may receive a QoS management descriptor TLV for the STA device 140 from the first AP device 110. The QoS management descriptor TLV includes the device identification and QOS management information for the STA device 140. For example, the QOS management descriptor TLV is received in a QoS management communication message from the first AP device 110. Next, the control device 130 may transmit the QOS management descriptor TLV to the second AP device 120.

Correspondingly, at the second AP device 120, the QOS management descriptor TLV may be received from the control device 130. For example, at the second AP device 120, the QOS management descriptor TLV is received in a service prioritization request message.

In some embodiments, the second AP device 120 and the STA device 140 may perform the communication through the following operations. For example, the second AP device 120 assigns the same device identification to the STA device 140 during performing, based on the device identification, an association process with the STA device 140. Correspondingly, at the STA device 140, during the performing, based on the device identification, the association process with the second AP device 120, the same device identification assigned by the second AP device 120 to the STA device 140 is obtained from second AP device 120.

In some embodiments, the control device 130 may perform the operation related to the STA device 140 through the following operations, and the STA device 140 and the second AP device 120 may perform the communication through the following operations. For example, the control device 130 may transmit an association control request TLV to the second AP device 120. The association control request TLV includes the device identification and association control information for the STA device 140. The STA device 140 transmits an association request message or a probe request message to the second AP device 120. The association request message or the probe request message includes the device identification. Correspondingly, at the second AP device 120, an association control request TLV is received from the control device 130, and the association request message or the probe request message is received from the STA device 140. Next, the second AP device 120 processes the association request message or the probe request message of the STA device 140 based on the association control information.

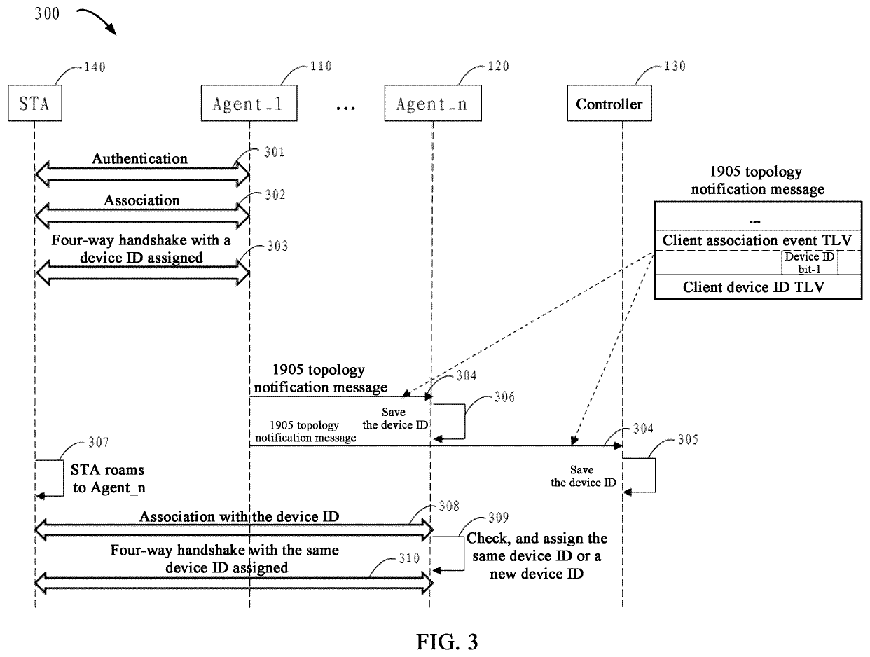

In some embodiments, the first AP device 110, the second AP device 120, and the control device 130 are compliance to a Wi-Fi Alliance EasyMesh specification. The following will provide a detailed explanation in conjunction with FIG. 3 to FIG. 7. In some embodiments of the present disclosure, it is assumed that APs and STAs in an EasyMesh network are compliance to a 802.11bh specification, so that the network focuses on the RCM and device IDs of the STAs during association.

FIG. 3 shows a schematic flowchart of an interaction between communication devices according to some embodiments of the present disclosure. As shown in FIG. 3, an agent associated with an STA propagates a device ID of the STA to a controller and the other agents. During a (re) association process, the agent determines whether the AP grants the device ID to the STA. If the AP grants the device ID to the STA, the agent would transmit a 1905 topology notification multicast message. The 1905 topology notification multicast message includes a client association event TLV, and a bit used by the device ID is set to 1. Therefore, the agent enables a new client device ID TLV to be included in the 1905 topology notification message, to propagate the device ID to each agent in the network.

Theoretically, different agents may assign variable Device ID to the same STA when the STA associates to it. In order to avoid tracking device ID change, the network can maintain the identical device ID cross the whole network. Once any agent in EasyMesh network assigns a device ID to one STA, this identical device ID will be kept unchanged until this STA leaves the network. Subsequently, when the STA associates to any other agent due to roaming, such identical and propagated device ID will be granted to the same STA.

Specifically, as shown in FIG. 3, an affiliated AP assigns the device ID to the STA and synchronizes the device ID to the entire EasyMesh network, as described in the following steps. It should be pointed out that in the context of describing the embodiments of the present disclosure, the term “step” may be an operation (or action) or a combination of a plurality of operations (or actions). A plurality of operations (or actions) belonging to one “step” do not necessarily have to be performed or occur simultaneously, but may occur in sequence. In addition, a plurality of operations (or actions) in one “step” may not necessarily be performed or occur in an order described herein, but may be performed or occur in other different orders.

Step 1: An STA performs authentication (301), association (302), and four-way handshake (303) to associate with Agent_1 in the EasyMesh network. During the four-way handshake, the STA obtains a device ID from Agent_1.

Step 2: Agent_1 transmits (304) a 1905 topology notification message to other agents and a controller, to indicate whether the device ID is used (if a device ID bit is set to 1, it indicates that the device ID is used; and if the device ID bit is set to 0, it indicates that the device ID is not used). In a case that the device ID is used, a new client device ID TLV is added into the 1905 topology notification message. The 1905 topology notification message includes the device ID, an RCM of the STA, and an AP MAC.

Step 3: When the 1905 topology notification message is received, the controller saves (305) the message as an identification of the STA and uses the message in a subsequent request message for the specific STA. The other agents will also keep (306) it.

Step 4: When this STA is associated with Agent_n due to roaming, Agent_n assigns the identical device ID to the same STA. Specifically, the STA performs (307) a roaming operation on Agent_n and associates (308) with Agent_n using the device ID. Agent_n checks (309) and assigns the same device ID or a new device ID. In a case that the same device ID is assigned, the STA performs (310) four-way handshake to achieve association with Agent_n in the EasyMesh network.

In Table 1 below, a bit referred to as the device ID bit has been extended in the client association event TLV to identify whether the client device ID is used. If the device ID is used, a new client device ID TLV defined in Table 2 is included in the 1905 topology notification message (which includes the STA device ID, the STA MAC, and the AP MAC).

TABLE 1
Client association event TLV

| Field | Length | | Value | Description |
|---|---|---|---|---|
| tlvType | 1 | octet | 0x92 | Client Association Event TLV. |
| tlvLength | 2 | octets | 13 | Number of octets in ensuing field. |
| tlvValue | 6 | octets | Any EUI-48 value | The MAC address of the client. |
| | 6 | octets | Any EUI-48 value | The BSSID of the BSS operated by the |
| | | | | Multi-AP Agent for which the event has |
| | | | | occurred. |
| | bit | 7 | 1: Client has joined the BSS | Association event. |
| | | | 0: Client has left the BSS | |
| | bit | 6 | 1: Client Device ID used | Device ID bit |
| | | | 0: Client Device ID not used | |
| | bits | 5-0 | 0 | Reserved |

TABLE 2
Client device ID TLV

| Field | Length | Value | Description |
|---|---|---|---|
| tlvType | 1 octet | 0xXX | Client Device ID TLV. |
| tlvLength | 2 octets | variable | Number of octets in ensuing |
| | | | field. |
| tlvValue | | | |
| AP_MAC | 6 octets | Any EUI-48 | the BSSID of the BSS. |
| | | value | |
| STA_MAC | 6 octets | Any EUI-48 | the MAC address of the client |
| | | value | |
| STA_DeviceID | variable | variable | the Device ID of the client. |

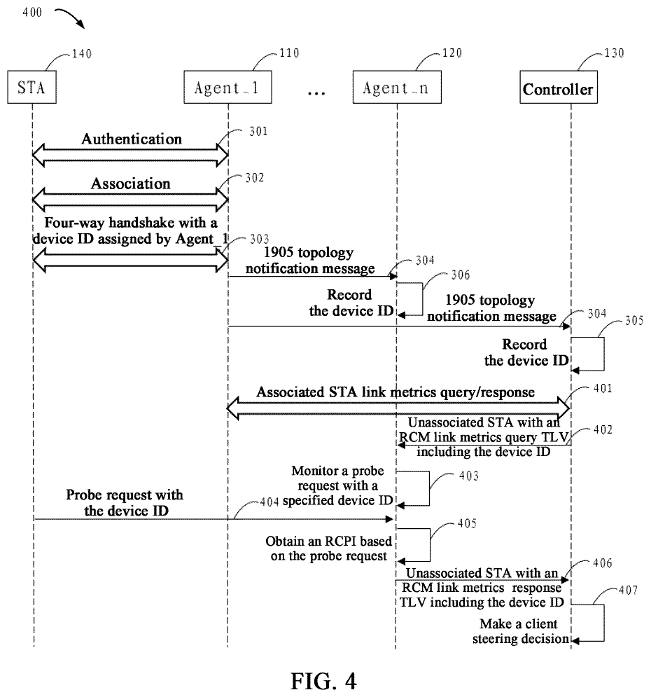

FIG. 4 shows a schematic flowchart of an interaction between communication devices according to some embodiments of the present disclosure. As shown in FIG. 4, unassociated STA link metrics are collected based on a device ID. Since a controller maintains information related to device IDs of STAs, before triggering a client roaming request, the controller may transmit a unassociated STA link metrics query including a device ID to collect a specified unassociated STA RCPI. Consequently, the unaffiliated AP is able to obtain the expected STA's RCPI information based on the Device ID carried in the probe request sent by the STA.

Specifically, as shown in FIG. 4, the unaffiliated AP collects unassociated STA link metrics for steering decisions. Before the controller makes a steering decision, it will collect specified STA RCPI information from affiliated and unaffiliated APs in case of RCM used by the STA, as shown in the following process.

Step 1: The controller uses associated STA link metrics query/response communication (401) to get STA metrics (e.g., RCPI, estimated data rate) from the affiliated AP.

Step 2: The controller transmits (402) an unassociated STA link metrics query message to the unaffiliated AP (Agent_2 to Agent_n). The message includes a new unassociated STA with RCM link metrics query TLV defined in Table 3.

Step 3: The unaffiliated AP (Agent_2 to Agent_n) monitors (403) the probe request sent from an STA with the device ID and obtains RCPI information based on it.

Step 4: The unaffiliated AP (Agent_2 to Agent_n) sends (406) an unassociated STA link metrics response message to the controller. The message includes a new unassociated STA with RCM link metrics response TLV defined in Table 4. On received such response, the controller will validate metrics based on the STA's device ID, but not the STA's MAC.

Step 5: The controller integrates metrics collected from the affiliated AP and the unaffiliated AP and makes (407) a client steering decision.

TABLE 3
Unassociated STA with the RCM link metrics query TLV

| Field/Name | Length | | Value | Description |
|---|---|---|---|---|
| tlvType | 1 | octet | 0xXX | Unassociated STA with RCM link |
| | | | | metrics query TLV. |
| tlvLength | 2 | octets | Variable | Number of octets in ensuing field. |
| tlvValue | | | | |
| | 1 | octet | Variable | Operating Class contains an |
| | | | | enumerated value from Table E-4 of [1] |
| | | | | [17], specifying the global operating |
| | | | | class in which the Channel List is valid. |
| | 1 | octet | k | Number of channels specified in the |
| | | | | Channel List. |
| | 1 | octet | Variable | Channel Number. |
| | | | | A channel number in the Operating |
| | | | | Class on which the RCPI |
| | | | | measurements are to be made. |
| | | | | Channel numbering dependent on |
| | | | | Operating Class according to Table E-4 |
| | | | | of [1] [17]. |
| | 1 | octet | m | Number of STA's MAC addresses for |
| | | | | this channel. |
| | 6 | octets | Any EUI-48 | STA's MAC address for which the |

| | | |
|---|---|---|
| | value | metrics are requested. |
| variable | variable | STA's Device ID for which the metrics |
| | | are requested. |

The above field is repeated m − 1 times.
The above three fields are repeated k − 1 times.

TABLE 4
Unassociated STA with the RCM link metrics response TLV

| Field/Name | Length | | Value | Description |
|---|---|---|---|---|
| tlvType | 1 | octet | 0xXX | Unassociated STA with RCM link |
| | | | | metrics response TLV. |
| tlvLength | 2 | octets | Variable | Number of octets in ensuing field. |
| tlvValue | | | | |
| | 1 | octet | Variable | Operating Class contains an |
| | | | | enumerated value from Table E-4 of [1] |
| | | | | [17], specifying the global operating |
| | | | | class for which the Channels in the |
| | | | | report apply. |
| | 1 | octet | k (>=0) | The number of STA entries included in |
| | | | | this TLV. |
| | 6 | octets | Any EUI-48 | MAC address of STA for which UL |
| | | | value | RCPI is being reported. |
| | Variable | | Variable | Device ID of STA for which UL RCPI |
| | | | | is being reported. |
| | 1 | octet | Variable | A single channel number in Operating |
| | | | | Class on which the RCPI measurement |
| | | | | for STA was made. |
| | | | | Channel numbering is dependent on |
| | | | | Operating Class according to Table E-4 |
| | | | | of [1] [17]. |
| | 4 | octets | Variable | The time delta in ms between the time |
| | | | | at which the RCPI for STA was |
| | | | | measured, and the time at which this |
| | | | | report was sent. |
| | 1 | octet | Variable | Uplink RCPI for STA. |

0-220:
RCPI
(encoded per
Table 9-176
of [1]).
221-255:
Reserved.

The above 4 fields are repeated k − 1 times
(if k = 0, these fields are omitted).

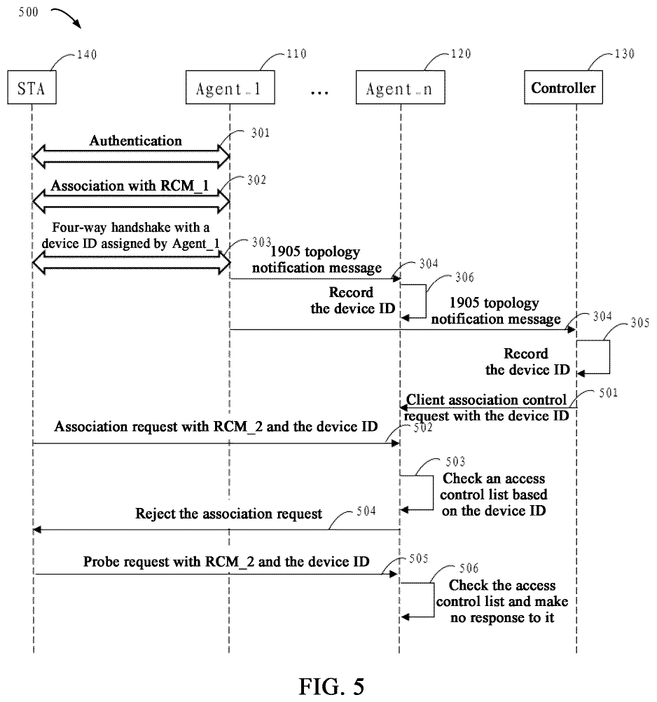

FIG. 5 shows a schematic flowchart of an interaction between communication devices according to some embodiments of the present disclosure. The process of FIG. 5 can achieve client association control based on a device ID. For some specific reasons, such as forced steering and parental control, the controller needs to block/unblock some STAs association to some of the APs in the EasyMesh network. With a client association control request message, the target AP can not identify the association request or probe request from the specified STA due to RCM use, which makes such control ineffective and failure. So, as illustrated in FIG. 5, such association control will change to be based on a device ID, but not MAC address. For example, the target AP (Agent_n) receives (501) a client association control request with a device ID from the controller, and receives (502) an association request with RCM_2 and the device ID from a specific STA. Next, the target AP (Agent_n) checks (503) an access control list based on the device ID and transmits (504) a reject association request to the STA. If the STA transmits (505) a probe request with RCM_2 and the device ID to the target AP, the target AP may check the access control list and not response (506) it.

According to the process in FIG. 5, a new client with an RCM association control request TLV is defined as Table 5 and added into the client association control request message.

TABLE 5
Client with the RCM association control request TLV

| Field/Name | Length | | Value | Description |
|---|---|---|---|---|
| tlvType | 1 | octet | 0xXX | Client with RCM Association |
| | | | | Control Request TLV. |
| tlvLength | 2 | octets | Variable | Number of octets in ensuing field. |
| tlvValue | | | | |
| BSSID | 6 | octets | Variable | Unique identifier of the BSS for |
| | | | | which the client blocking request |
| | | | | applies. |
| Association | 1 | octet | 0x00: Block | Indicates if the request is to block |
| control | | | 0x01: Unblock | or unblock the indicated STAs |
| | | | 0x02: Timed block | from associating. |
| | | | 0x03: Indefinite block | |
| | | | 0x04-0xFF: Reserved | |
| Validity | 2 | octets | Variable | Time period in seconds (from |
| Period | | | | reception of the Client Association |
| | | | | Control Request message) for |
| | | | | which a blocking request is valid. |
| STA list | 1 | octet | k | Indicates one or more STA(s) for |

| | | | |
|---|---|---|---|
| count | | | which Client Association Control |
| | | | request applies. |
| Device ID | Variable | Variable | STA Device ID(s) for which the |
| | | | Client Association Control request |
| | | | applies. |

The above field is repeated k − 1 times.

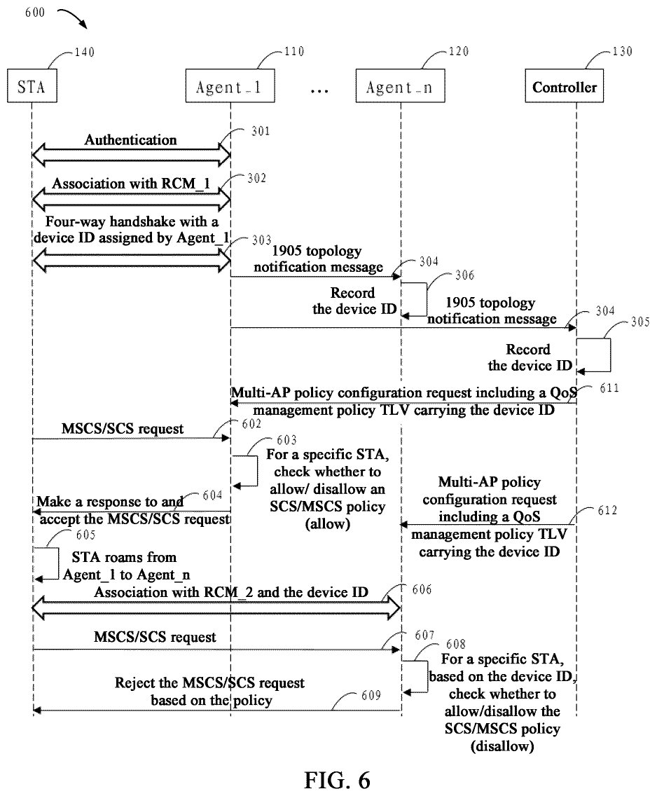

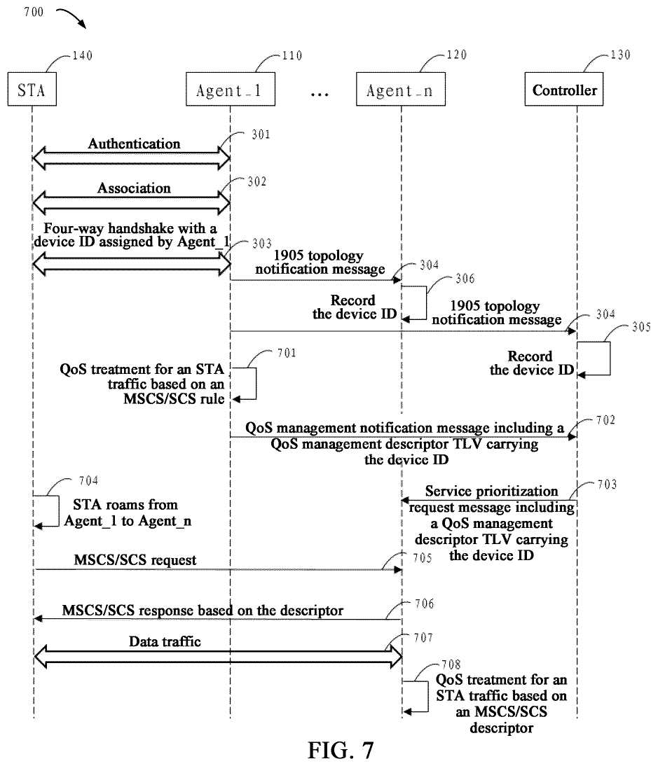

FIG. 6 and FIG. 7 respectively show schematic flowcharts of an interaction between communication devices according to some embodiments of the present disclosure. Specifically, the process shown in FIG. 6 achieves configuring a QoS management policy based on a device ID. The process shown in FIG. 7 achieves configuring a QoS management descriptor based on a device ID.

Normally, QOS management policy and configuration need to be propagated to the other agents by the controller so that each of the agents keeps the aligned QoS treatment when a STA triggers SCS/MSCS request to any of them. In case of RCM used, a device ID needs to be used to identify the STA which this policy or descriptor applies for. When the controller propagates a QoS management descriptor to other unaffiliated agents, a new QoS management policy TLV carrying a device ID needs to be included in a multi-AP policy configuration request message.

In other words, when the controller configures, to an agent, a QoS management policy for a specific STA, the MAC and device ID of the STA may be included in the new Qos management policy TLV carrying the device ID. When a specific STA triggers SCS/MSCS negotiation, any agent is able to effectively allow/disallow the SCS/MSCS negotiation according to the configured policy. For the process, refer to the schematic diagram of transmission of the QoS management policy shown in FIG. 6.

Step 1: The controller transmits (611, 612) a multi-AP policy configuration request. The multi-AP policy configuration request includes a QoS management policy TLV carrying a device ID. A definition of the device ID can be found in Table 6 below.

Step 2: An STA associated with Agent_1 has RCM 1 and the device ID.

Step 3: The STA transmits (602) an MSCS/SCS request to Agent_1.

Step 4: For a specific STA, Agent_1 checks (603) whether an MSCS/SCS policy is allowed or disallowed.

Step 5: If an MSCS/SCS operation is allowed, Agent_1 transmits (604) a response to the STA and accepts the MSCS/SCS request.

Step 6: The STA may roam (605) from Agent_1 to Agent_n and may perform (606) association with Agent_n using the RCM and the device ID. The STA associated with Agent_n has RCM_2 and the device ID.

Step 7: The STA transmits (607) the MSCS/SCS request to Agent_n.

Step 8: For the specific STA, Agent_n checks (608) whether the MSCS/SCS policy is allowed or disallowed. For example, in a case that RCM_1 and RCM_2 are different, Agent_n can perform the check based on the device ID.

Step 9: If Agent_n disallows the MSCS/SCS operation, Agent_n may reject (609) the MSCS/SCS request.

TABLE 6
QoS management policy TLV carrying the device ID

| Field/Name | Length | | Value | Description |
|---|---|---|---|---|
| tlvType | 1 | octet | 0xDB | STA with RCM MSCS/SCS |
| | | | | Policy TLV. |
| tlvLength | 2 | octets | Variable | Number of octets in ensuing |
| | | | | field. |
| tlvValue | | | | |
| numMSCSDisallowed | 1 | octet | Variable | Number of STAs for which |
| | | | | MSCS operation is disallowed |
| MSCS Disallowed STA | Variable | | Variable | Device ID of STA for which |
| Device ID List | | | | MSCS operation is disallowed |
| | | | | The above field is repeated |
| | | | | numMSCSDiallowed times |
| numSCSDisallowed | 1 | octet | Variable | Number of STAs for which |
| | | | | SCS operation is disallowed |
| SCS Disallowed STA | Variable | | Variable | Device ID of STA for which |
| Device ID List | | | | SCS operation is disallowed |
| | | | | The above field is repeated |
| | | | | numSCSDisallowed times |
| | 20 | octets | | Reserved |

For details of the SCS/MSCS negotiation, if the controller desires to propagate an MSCS/SCS descriptor or a DSCP policy descriptor to other unaffiliated APs, a new defined Device ID based QoS Management Descriptor TLV in Table 7, which includes STA Device ID, will be added into Service Prioritization Request message.

In other words, when the controller desires to control the details of QoS treatment for a specific STA, the controller propagates the QoS management descriptor to any agent, and the MAC and device ID of the STA may be included in the new device ID based QoS management descriptor TLV. Then, when a matching service transmitted by the specific STA is forwarded, any agent can take aligned QoS treatment based on the propagated SCS/MSCS descriptor. For the process, refer to the schematic diagram of propagation of the QoS management descriptor shown in FIG. 7. Specifically, Agent_1 may perform (701) QoS treatment for an STA traffic based on an MSCS/SCS rule, and transmit (702) a QoS management notification message including the QoS management descriptor TLV carrying the device ID to the controller. The controller may transmit (703) the service prioritization request message including the QoS management descriptor TLV carrying the device ID to Agent_n. The STA may roam (704) from Agent_1 to Agent_n. Next, the STA transmits (705) the MSCS/SCS request to Agent_n. Agent_n may transmit (706) an MSCS/SCS responses to the STA based on the descriptor. Communication (707) for data traffic can be achieved between the STA and Agent_n. Agent_n can perform (708) the QoS treatment for the STA traffic based on the MSCS/SCS descriptor.

TABLE 7
QoS management descriptor TLV based on the device ID

| Field/Name | Length | | Value | Description |
|---|---|---|---|---|
| tlvType | 1 | octet | 0xDC | DeviceID based QoS Management |
| | | | | Descriptor TLV. |
| tlvLength | 2 | octets | Variable | Number of octets in ensuing field. |
| tlvValue | | | | |
| QMID | 2 | octets | Variable | An identifier that uniquely |
| | | | | identifies a QoS Management rule. |
| BSSID | 6 | octets | Variable | BSSID of BSS for which this |
| | | | | descriptor applies. |
| Client MAC | 6 | octets | Variable | MAC address of STA for which |

| | | | |
|---|---|---|---|
| | | | this descriptor applies |
| Client | Variable | Variable | Device ID of STA for which this |
| Device ID | | | descriptor applies |
| Descriptor | Variable | Variable | One of: |
| Element | | | MSCS Descriptor element |
| | | | (as described in Section |
| | | | 9.4.2.243 of [1] or |
| | | | SCS Descriptor element |
| | | | (as described in Section |
| | | | 9.4.2.121 of [1] and [28] or |
| | | | QoS Management element |
| | | | (as described in Section 5.3 |
| | | | of [25]) |

By using the technical solutions of the embodiments of the present disclosure, each individual STA with an RCM can be identified and tracked by the EasyMesh network after association. The following use case broken issue caused by RCM can be addressed. First, network topology and STA related measurements can be correctly collected. In addition, unassociated STA link metrics can be correctly collected, and suitable client steering decision can be made for network optimization. Further, QoS management policy and descriptor configuration about MSCS/SCS and DSCP policy can be correctly propagated in the EasyMesh network to guarantee correct and aligned QoS treatment for a specific STA. Furthermore, implementing the use of device IDs on APs and STAs in a multi-AP network environment solves the potential problems caused by the fact that STAs use RCMs.

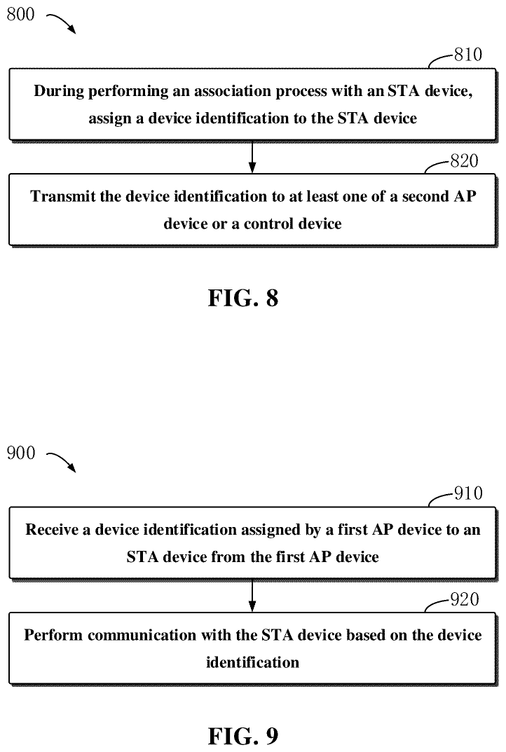

FIG. 8 shows a schematic diagram of a flow performed by a first AP device 110 according to some embodiments of the present disclosure. As shown in FIG. 8, in a flow 800, at block 810, during performing an association process with an STA device 140, a device identification is assigned to the STA device 140. At block 820, the device identification is transmitted to at least one of a second AP device 120 or a control device 130.

In some embodiments, the device identification is transmitted in a 1905 topology notification message.

In some embodiments, the 1905 topology notification message includes a client association event type length value (TLV). The client association event TLV includes bit information, and the bit information is used for indicating whether the device identification is used.

In some embodiments, the 1905 topology notification message further includes a client device identification TLV; and the client device identification TLV includes the device identification and at least one of the following: a media access control (MAC) address of the STA device 140; or a MAC address of the first AP device 110.

In some embodiments, the first AP device 110 is further caused to: receive a quality of service (QOS) management policy TLV from the control device 130, where the QoS management policy TLV includes a list of device identifications for which QoS treatment negotiation is disallowed.

In some embodiments, the first AP device 110 is further caused to: receive a QoS treatment negotiation request from the STA device 140; and determine, based on the QoS management policy TLV, whether to allow the QoS treatment negotiation request of the STA device 140.

In some embodiments, the first AP device 110 is further caused to: transmit a QoS management descriptor TLV to the control device 130, where the QoS management descriptor TLV includes the device identification and QoS treatment information for a data traffic of the STA device 140.

In some embodiments, the QoS management descriptor TLV is transmitted in a QoS management notification message.

In some embodiments, the first AP device 110, the second AP device 120, and the control device 130 are compliance to a Wi-Fi Alliance EasyMesh specification.

FIG. 9 shows a schematic diagram of a flow performed by a second AP device 120 according to some embodiments of the present disclosure. As shown in FIG. 9, in a flow 900, at block 910, a device identification assigned by a first AP device 110 to an STA device 140 is received from the first AP device 110. At block 920, communication with the STA device 140 is performed based on the device identification.

In some embodiments, the second AP device 120 is further caused to: store the device identification.

In some embodiments, the device identification is received in a 1905 topology notification message.

In some embodiments, the 1905 topology notification message includes a client association event type length value (TLV). The client association event TLV includes bit information, and the bit information is used for indicating whether the device identification is used.

In some embodiments, the 1905 topology notification message further includes a client device identification TLV; and the client device identification TLV includes the device identification and at least one of the following: a media access control (MAC) address of the STA device 140; or a MAC address of the first AP device 110.

In some embodiments, the second AP device 120 is caused to perform the communication with the STA device 140 by: assigning a same device identification to the STA device 140 during performing, based on the device identification, an association process with the STA device 140.

In some embodiments, the second AP device 120 is caused to perform the communication with the STA device 140 by: receiving, from a control device 130, a link metrics query TLV for the STA device 140, where the link metrics query TLV includes the device identification; monitoring, based on the received link metrics query TLV, a probe request message transmitted by the STA device 140, where the probe request message includes the device identification; in a case that the probe request message has been monitored, obtaining link metrics information of the STA device 140 based on the probe request message; and transmitting a link metrics response TLV to the control device 130, where the link metrics response TLV includes the device identification and the link metrics information.

In some embodiments, the second AP device 120 is further caused to: receive a quality of service (QOS) management policy TLV from the control device 130, where the QoS management policy TLV includes a list of device identifications for which QoS treatment negotiation is disallowed.

In some embodiments, the second AP device 120 is caused to perform the communication with the STA device 140 by: receiving a QoS treatment negotiation request from the STA device 140; and determining, based on the QoS management policy TLV, whether to allow the QoS treatment negotiation request of the STA device 140.

In some embodiments, the second AP device 120 is further caused to: receive a QoS management descriptor TLV from the control device 130, where the QoS management descriptor TLV includes the device identification and QoS management information for the STA device 140.

In some embodiments, the QOS management descriptor TLV is received in a service prioritization request message.

In some embodiments, the second AP device 120 is caused to perform the communication with the STA device 140 by: receiving an association control request TLV from the control device 130, where the association control request TLV includes the device identification and association control information for the STA device 140; receiving an association request message or a probe request message from the STA device 140, where the association request message or the probe request message includes the device identification; and processing the association request message or the probe request message of the STA device 140 based on the association control information.

In some embodiments, the first AP device 110, the second AP device 120, and the control device 130 are compliance to a Wi-Fi Alliance EasyMesh specification.

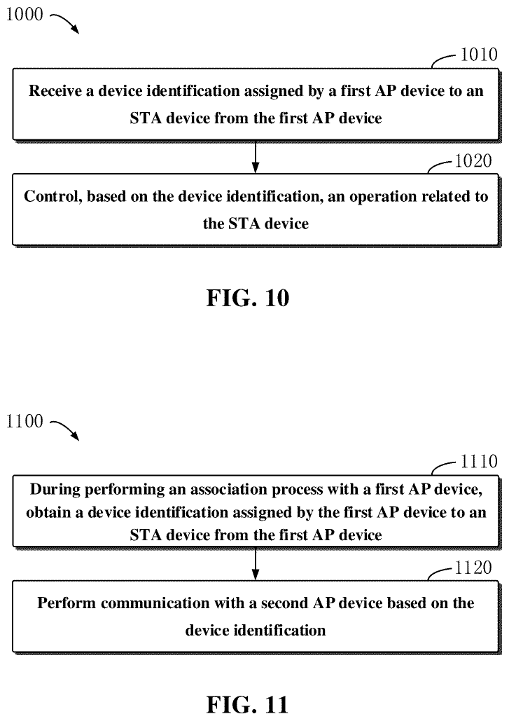

FIG. 10 shows a schematic diagram of a flow performed by a control device 130 according to some embodiments of the present disclosure. As shown in FIG. 10, in a flow 1000, at block 1010, a device identification assigned by a first AP device 110 to an STA device 140 is received from the first AP device 110. At block 1020, an operation related to the STA device 140 is controlled based on the device identification.

In some embodiments, the control device 130 is further caused to: store the device identification.

In some embodiments, the device identification is received in a 1905 topology notification message.

In some embodiments, the 1905 topology notification message includes a client association event type length value (TLV). The client association event TLV includes bit information, and the bit information is used for indicating whether the device identification is used.

In some embodiments, the 1905 topology notification message further includes a client device identification TLV; and the client device identification TLV includes the device identification and at least one of the following: a media access control (MAC) address of the STA device 140; or a MAC address of the first AP device 110.

In some embodiments, the control device 130 is caused to perform the operation related to the STA device 140 by: transmitting a link metrics query TLV for the STA device 140 to a second AP device 120, where the link metrics query TLV includes the device identification; and receiving a link metrics response TLV from the second AP device 120, where the link metrics response TLV includes the device identification and link metrics information of the STA device 140.

In some embodiments, the control device 130 is caused to perform the operation related to the STA device 140 by: transmitting a quality of service (QOS) management policy TLV to at least one of the first AP device 110 or the second AP device 120, where the QoS management policy TLV includes a list of device identifications for which QoS treatment negotiation is disallowed.

In some embodiments, the control device 130 is caused to perform the operation related to the STA device 140 by: receiving a QoS management descriptor TLV for the STA device 140 from the first AP device 110, where the QoS management descriptor TLV includes the device identification and QOS management information for the STA device 140; and transmitting the QoS management descriptor TLV to the second AP device 120.

In some embodiments, the QOS management descriptor TLV is received in a QoS management communication message from the first AP device 110; or the QoS management descriptor TLV is transmitted in a service prioritization request message to the second AP device 120.

In some embodiments, the control device 130 is caused to perform the operation related to the STA device 140 by: transmitting an association control request TLV to the second AP device 120, where the association control request TLV includes the device identification and association control information for the STA device 140.

In some embodiments, the first AP device 110, the second AP device 120, and the control device 130 are compliance to a Wi-Fi Alliance EasyMesh specification.

FIG. 11 shows a schematic diagram of a flow performed by an STA device 140 according to some embodiments of the present disclosure. As shown in FIG. 11, in a flow 1100, at block 1110, during performing an association process with a first AP device 110, a device identification assigned by the first AP device 110 to the STA device 140 is obtained from the first AP device 110. At block 1120, communication with a second AP device 120 is performed based on the device identification.

In some embodiments, the STA device 140 is caused to perform the communication with the second AP device 120 by: during the performing, based on the device identification, the association process with the second AP device 120, obtaining the same device identification assigned by the second AP device 120 to the STA device 140 from the second AP device 120.

In some embodiments, the STA device 140 is caused to perform the communication with the second AP device 120 by: transmitting a probe request message to the second AP device 120, where the probe request message includes the device identification.

In some embodiments, the STA device 140 is caused to perform the communication with the second AP device 120 by: transmitting an association request message or a probe request message to the second AP device 120. The association request message or the probe request message includes the device identification.

In some embodiments, the first AP device 110, the second AP device 120, and the control device 130 belong to an EasyMesh network.

In some exemplary embodiments, an apparatus capable of performing the method 800 (for example, at the first AP device 110) may comprise means for performing the respective steps of the method 800. The means may be implemented in any suitable form. For example, the means may be implemented in a circuitry or software module.

In some embodiments, the apparatus may include: means for assigning a device identification to an STA device 140 during performing an association process with the STA device 140; and means for transmitting the device identification to at least one of a second AP device 120 or a control device 130.

In some embodiments, the device identification is transmitted in a 1905 topology notification message.

In some embodiments, the 1905 topology notification message includes a client association event type length value (TLV). The client association event TLV includes bit information, and the bit information is used for indicating whether the device identification is used.

In some embodiments, the 1905 topology notification message further includes a client device identification TLV; and the client device identification TLV includes the device identification and at least one of the following: a media access control (MAC) address of the STA device 140; or a MAC address of the first AP device 110.

In some embodiments, the apparatus may further include: means for receiving a quality of service (QOS) management policy TLV from the control device 130, where the QoS management policy TLV includes a list of device identifications for which QoS treatment negotiation is disallowed.

In some embodiments, the apparatus may further include: means for receiving a QoS treatment negotiation request from the STA device 140; and means for determining, based on the QoS management policy TLV, whether to allow the QoS treatment negotiation request of the STA device 140.

In some embodiments, the apparatus further includes: means for transmitting a QoS management descriptor TLV to the control device 130, where the QoS management descriptor TLV includes the device identification and QoS treatment information for a data traffic of the STA device 140.

In some embodiments, the QOS management descriptor TLV is transmitted in a QoS management notification message.

In some embodiments, the first AP device 110, the second AP device 120, and the control device 130 are compliance to a Wi-Fi Alliance EasyMesh specification.

In some embodiments, the apparatus further includes means for performing other steps in some embodiments of the method 800. In some embodiments, the means comprises at least one processor and at least one memory storing computer program code, the at least one memory and computer program code configured to, with the at least one processor, cause the performance of the apparatus.

In some exemplary embodiments, an apparatus capable of performing the method 900 (for example, at the second AP device 120) may comprise means for performing the respective steps of the method 900. The means may be implemented in any suitable form. For example, the means may be implemented in a circuitry or software module.

In some embodiments, the apparatus may include: means for receiving, from a first AP device 110, a device identification assigned by the first AP device 110 to an STA device 140; and means for performing communication with the STA device 140 based on the device identification.

In some embodiments, the apparatus may further include: means for storing the device identification.

In some embodiments, the device identification is received in a 1905 topology notification message.

In some embodiments, the 1905 topology notification message includes a client association event type length value (TLV). The client association event TLV includes bit information, and the bit information is used for indicating whether the device identification is used.

In some embodiments, the 1905 topology notification message further includes a client device identification TLV; and the client device identification TLV includes the device identification and at least one of the following: a media access control (MAC) address of the STA device 140; or a MAC address of the first AP device 110.

In some embodiments, the means for performing the communication with the STA device 140 includes: means for assigning a same device identification to the STA device 140 during performing, based on the device identification, an association process with the STA device 140.

In some embodiments, the means for performing the communication with the STA device 140 includes: means for receiving, from a control device 130, a link metrics query TLV for the STA device 140, where the link metrics query TLV includes the device identification; means for monitoring, based on the received link metrics query TLV, a probe request message transmitted by the STA device 140, where the probe request message includes the device identification; means for, in a case that the probe request message has been monitored, obtaining link metrics information of the STA device 140 based on the probe request message; and means for transmitting a link metrics response TLV to the control device 130, where the link metrics response TLV includes the device identification and the link metrics information.

In some embodiments, the apparatus further includes: means for receiving a quality of service (QOS) management policy TLV from the control device 130, where the QoS management policy TLV includes a list of device identifications for which QoS treatment negotiation is disallowed.

In some embodiments, the means for performing the communication with the STA device 140 includes: means for receiving a QoS treatment negotiation request from the STA device 140; and means for determining, based on the QoS management policy TLV, whether to allow the QoS treatment negotiation request of the STA device 140.

In some embodiments, the apparatus further includes: means for receiving a QoS management descriptor TLV from the control device 130, where the QoS management descriptor TLV includes the device identification and QoS management information for the STA device 140.

In some embodiments, the QOS management descriptor TLV is received in a service prioritization request message.

In some embodiments, the means for performing the communication with the STA device 140 includes: means for receiving an association control request TLV from the control device 130, where the association control request TLV includes the device identification and association control information for the STA device 140; means for receiving an association request message or a probe request message from the STA device 140, where the association request message or the probe request message includes the device identification; and means for processing the association request message or the probe request message of the STA device 140 based on the association control information.

In some embodiments, the first AP device 110, the second AP device 120, and the control device 130 are compliance to a Wi-Fi Alliance EasyMesh specification.

In some embodiments, the apparatus further includes means for performing other steps in some embodiments of the method 400. In some embodiments, the means comprises at least one processor and at least one memory storing computer program code, the at least one memory and computer program code configured to, with the at least one processor, cause the performance of the apparatus.

In some exemplary embodiments, an apparatus capable of performing the method 1000 (for example, at the control device 130) may comprise means for performing the respective steps of the method 1000. The means may be implemented in any suitable form. For example, the means may be implemented in a circuitry or software module.

In some embodiments, the apparatus may include: means for receiving, from a first AP device 110, a device identification assigned by the first AP device 110 to an STA device 140; and means for controlling, based on the device identification, an operation related to the STA device 140.

In some embodiments, the apparatus further includes: means for storing the device identification.

In some embodiments, the device identification is received in a 1905 topology notification message.

In some embodiments, the 1905 topology notification message includes a client association event type length value (TLV). The client association event TLV includes bit information, and the bit information is used for indicating whether the device identification is used.

In some embodiments, the 1905 topology notification message further includes a client device identification TLV; and the client device identification TLV includes the device identification and at least one of the following: a media access control (MAC) address of the STA device 140; or a MAC address of the first AP device 110.

In some embodiments, the means for performing the operation related to the STA device 140 includes: means for transmitting a link metrics query TLV for the STA device 140 to a second AP device 120, where the link metrics query TLV includes the device identification; and means for receiving a link metrics response TLV from the second AP device 120, where the link metrics response TLV includes the device identification and link metrics information of the STA device 140.

In some embodiments, the means for performing the operation related to the STA device 140 includes: means for transmitting a quality of service (QOS) management policy TLV to at least one of the first AP device 110 or the second AP device 120, where the QoS management policy TLV includes a list of device identifications for which QoS treatment negotiation is disallowed.

In some embodiments, the means for performing the operation related to the STA device 140 includes: means for receiving a QoS management descriptor TLV for the STA device 140 from the first AP device 110, where the QoS management descriptor TLV includes the device identification and QoS management information for the STA device 140; and means for transmitting the QoS management descriptor TLV to the second AP device 120.

In some embodiments, the QOS management descriptor TLV is received in a QoS management communication message from the first AP device 110; or the QoS management descriptor TLV is transmitted in a service prioritization request message to the second AP device 120.

In some embodiments, the means for performing the operation related to the STA device 140 includes: means for transmitting an association control request TLV to the second AP device 120, where the association control request TLV includes the device identification and association control information for the STA device 140.

In some embodiments, the first AP device 110, the second AP device 120, and the control device 130 are compliance to a Wi-Fi Alliance EasyMesh specification.

In some embodiments, the apparatus further includes means for performing other steps in some embodiments of the method 1000. In some embodiments, the means comprises at least one processor and at least one memory storing computer program code, the at least one memory and computer program code configured to, with the at least one processor, cause the performance of the apparatus.

In some exemplary embodiments, an apparatus capable of performing the method 1100 (for example, at the STA device 140) may comprise means for performing the respective steps of the method 1100. The means may be implemented in any suitable form. For example, the means may be implemented in a circuitry or software module.

In some embodiments, the apparatus includes: means for obtaining, during performing an association process with a first AP device 110 and from the first AP device 110, a device identification assigned by the first AP device 110 to the STA device 140; and means for performing communication with a second AP device 120 based on the device identification.

In some embodiments, the means for performing the communication with the second AP device 120 includes: means for, during the performing, based on the device identification, the association process with the second AP device 120, obtaining the same device identification assigned by the second AP device 120 to the STA device 140 from the second AP device 120.

In some embodiments, the means for performing the communication with the second AP device 120 includes: means for transmitting a probe request message to the second AP device 120, where the probe request message includes the device identification.

In some embodiments, the means for performing the communication with the second AP device 120 includes: means for transmitting an association request message or a probe request message to the second AP device 120, where the association request message or the probe request message includes the device identification.

In some embodiments, the first AP device 110, the second AP device 120, and the control device 130 belong to an EasyMesh network.

In some embodiments, the apparatus further includes means for performing other steps in some embodiments of the method 1100. In some embodiments, the means comprises at least one processor and at least one memory storing computer program code, the at least one memory and computer program code configured to, with the at least one processor, cause the performance of the apparatus.

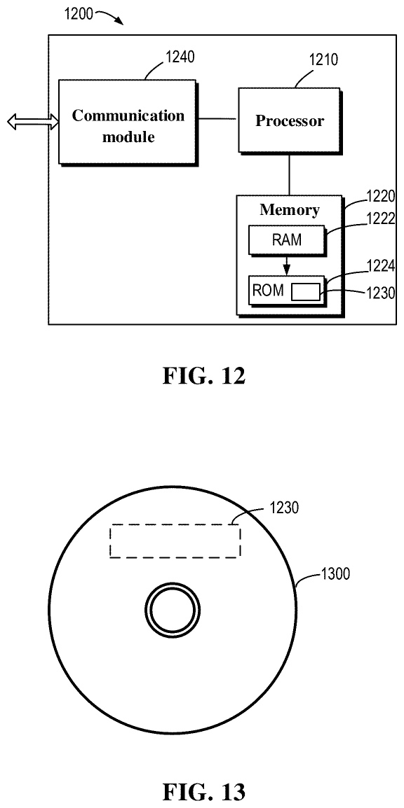

FIG. 12 is a simplified block diagram of an electronic device 1200 suitable for implementing the embodiments of the present disclosure. The device 1200 can be provided to implement a communication device, such as the communication devices 110, 120, 130, and 140 as shown in FIG. 1. As shown in the figure, the device 1200 includes one or more processors 1210, one or more memories 1220 coupled to the processor 1210, and one or more communication modules 1240 coupled to the processor 1210.

The communication modules 1240 is for bidirectional communications. For example, the communication modules 1240 may include a transmitter, a receiver, or a transceiver for the embodiments of the present disclosure. A communication interface can represent any interface necessary for communication with other network elements.

The processors 1210 may be of any type suitable to the local technical network and may include one or more of the following: general purpose computers, special purpose computers, microprocessors, digital signal processors (DSPs), and controller-based multi-core controller architecture, as non-limiting examples. The device 1200 may have multiple processors, such as an application specific integrated circuit chip that is slaved in time to a clock which synchronizes the main processor.

The memories 1220 may include one or more non-volatile memories and one or more volatile memories. Examples of the non-volatile memories include, but are not limited to, a Read Only Memory (ROM) 1224, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 1222 and other volatile memories that will not last in the power-down duration.

Computer programs 1230 include computer executable instructions that are executed by the associated processor 1210. The program 1230 may be stored in the ROM 1224. The processor 1210 may perform any suitable actions and processing by loading the program 1230 into the RAM 1222.

The embodiments of the present disclosure may be implemented by means of the program 1230 so that the device 1200 may perform any process of the disclosure as discussed with reference to FIGS. 2 to 7. The embodiments of the present disclosure may also be implemented by hardware or by a combination of software and hardware.

In some embodiments, the programs 1230 may be tangibly contained in a computer-readable medium which may be included in the device 1200 (such as in the memory 1220) or other storage devices that are accessible by the device 1200. The program 1230 may be loaded from the computer-readable medium to the RAM 1222 for execution. The computer-readable medium may include any types of tangible non-volatile storage, such as ROM, EPROM, a flash memory, a hard disk, CD, DVD, and the like.

FIG. 13 shows an example of a computer-readable medium 1300 in the form of CD or DVD. A program 1230 is stored on the computer-readable medium.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The embodiments of the present disclosure also provide at least one computer program product tangibly stored on a non-transitory computer-readable storage medium. The computer program product includes computer-executable instructions, such as those included in program modules, being executed in a device on a target real or virtual processor, to carry out the methods 800, 900, 1000, and 1100, as described above with reference to FIGS. 8 to 11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Computer program codes for carrying out methods of the embodiments of the present disclosure may be written in one or more programming languages. These computer program codes may be provided to a processor of a general purpose computer, special purpose computer, or other programmable data processing apparatus, such that the program codes, when executed by the computer or other programmable data processing apparatus, cause the functions/operations specified in the flowcharts and/or block diagrams to be implemented. The program code may be executed entirely on a machine, partly on the machine, as a stand-alone software package, partly on the machine and partly on a remote machine or entirely on the remote machine or server.

In the context of the embodiments of the present disclosure, the computer program codes or related data may be carried by any appropriate carrier to enable devices, apparatuses, or processors to perform the various processing and operations described above. Examples of the carrier include signals, computer-readable media, and the like. Examples of the signals can include electrical signals, optical signals, radio signals, sound signals, or other forms of propagation signals, such as carrier waves and infrared signals.

The computer-readable medium can be any tangible medium that contains or stores programs used for or related to instruction execution systems, apparatuses, or devices. The computer-readable medium can be a computer-readable signal medium or a computer-readable storage medium. The computer-readable medium may include but is not limited to electronic, magnetic, optical, electromagnetic, infrared, or semiconductor systems, apparatuses, or devices, or any suitable combination thereof. More detailed examples of the computer-readable storage medium include an electrical connection having one or more wires, a portable computer diskette, a hard disk, a random access memory (RAM), a read-only memory (ROM), an erasable programmable read-only memory (EPROM or Flash memory), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

In addition, although the operations of the methods of the embodiments of the present disclosure are described in a specific order in the accompanying drawings, this does not require or imply that these operations need to be performed in this specific order, or that all the shown operations need to be performed to achieve desired results. On the contrary, the order of execution of the steps depicted in the flowcharts can be changed. Additionally or alternatively, some steps can be omitted; multiple steps can be combined into one step for execution; and/or a step can be decomposed into multiple steps for execution. It should also be noted that features and functions of two or more apparatuses of the embodiments of the present disclosure can be concretized in one apparatus. On the contrary, the features and functions of an apparatus described above can be further divided into multiple apparatuses for concretization.

Although several specific embodiments have been referred to describe the embodiments of the present disclosure, it should be understood that the present disclosure is not limited to the specific embodiments disclosed. The present disclosure aims to cover various modifications and equivalent arrangements included in the spirit and scope of the attached claims.

The invention claimed is:

1. A first access point (AP) device, comprising:
at least one processor; and
at least one memory storing instructions that, when executed by the at least one processor, cause the first AP device at least to:
assign a device identification to a station (STA) device during performing an association process with the STA device; and
transmit the device identification to at least one of a second AP device or a control device.

2. The first AP device according to claim 1, wherein the device identification is transmitted in a 1905 topology notification message.

3. The first AP device according to claim 2, wherein the 1905 topology notification message comprises a client association event type length value (TLV); the client association event TLV comprises bit information; and the bit information is used for indicating whether the device identification is used.

4. The first AP device according to claim 2, wherein the 1905 topology notification message further comprises a client device identification TLV; and the client device identification TLV comprises the device identification and at least one of the following:
a media access control (MAC) address of the STA device; or
a MAC address of the first AP device.

5. The first AP device according to claim 1, wherein the first AP device is further caused to:
receive a quality of service (QOS) management policy TLV from the control device, wherein the QoS management policy TLV comprises a list of device identifications for which QoS treatment negotiation is disallowed.

6. The first AP device according to claim 5, wherein the first AP device is further caused to:
receive a QoS treatment negotiation request from the STA device; and
determine, based on the QoS management policy TLV, whether to allow the QoS treatment negotiation request of the STA device.

7. The first AP device according to claim 1, wherein the first AP device is further caused to:
transmit a QoS management descriptor TLV to the control device, wherein the QoS management descriptor TLV comprises the device identification and QoS treatment information for a data traffic of the STA device.

8. The first AP device according to claim 7, wherein the QoS management descriptor TLV is transmitted in a QoS management notification message.

9. The first AP device according to claim 1, wherein the first AP device, the second AP device, and the control device are compliance to a Wi-Fi Alliance EasyMesh specification.

10. A second access point (AP) device, comprising:
at least one processor; and
at least one memory storing instructions that, when executed by the at least one processor, cause the second AP device at least to:
receive, from a first AP device, a device identification assigned by the first AP device to a station (STA) device; and
perform communication with the STA device based on the device identification.

11. The second AP device according to claim 10, wherein the second AP device is further caused to:
store the device identification.

12. The second AP device according to claim 10, wherein the device identification is received in a 1905 topology notification message.

13. The second AP device according to claim 12, wherein the 1905 topology notification message comprises a client association event type length value (TLV); the client association event TLV comprises bit information; and the bit information is used for indicating whether the device identification is used.

14. (canceled)

15. (canceled)

16. (canceled)

17. (canceled)

18. (canceled)

19. (canceled)

20. (canceled)

21. (canceled)

22. (canceled)

23. A control device, comprising:
at least one processor; and
at least one memory storing instructions that, when executed by the at least one processor, cause the control device at least to:
receive, from a first access point (AP) device, a device identification assigned by the first AP device to a station (STA) device; and
control, based on the device identification, an operation related to the STA device.

24. The control device according to claim 23, wherein the control device is further caused to:
store the device identification.

25. The control device according to claim 23, wherein the device identification is received in a 1905 topology notification message.

26. (canceled)

27. (canceled)

28. (canceled)

29. (canceled)

30. (canceled)

31. (canceled)

32. (canceled)

33. (canceled)

34. A method, comprising:
assigning, at a first access point (AP) device, a device identification to a station (STA) device during performing an association process with the STA device; and
transmitting the device identification to at least one of a second AP device or a control device.

35. (canceled)

36. (canceled)

37. (canceled)

38. (canceled)

39. (canceled)

40. (canceled)
